(19) United States
(12) Patent Application Publication
(10) Pub. No.: US 2015/0186180 A1
(43) Pub. Date: Jul. 2, 2015

(54) SYSTEMS AND METHODS FOR AFFINITY DISPATCHING BASED ON NETWORK INPUT/OUTPUT REQUESTS

(71) Applicants: David W. Schroth, Roseville, MN (US); Michael J. Rieschl, Roseville, MN (US)

(72) Inventors: David W. Schroth, Roseville, MN (US); Michael J. Rieschl, Roseville, MN (US)

(21) Appl. No.: 14/143,261

(22) Filed: Dec. 30, 2013

(51) Int. Cl. G06F 9/48

(52) U.S. Cl. CPC G06F 9/4812

(57) ABSTRACT

Systems and methods for network input/output affinity dispatching are provided. Embodiments may include detecting a completion of at least one of a network input operation and a network output operation, and identifying a communication task waiting for the completion. Embodiments may also include adjusting a first affinity queue associated with the communication task, and executing the communication task in accordance with the adjusted first affinity queue.

### FIELD OF THE DISCLOSURE

The instant disclosure relates to computer systems. More specifically, this disclosure relates to affinity scheduling.

### BACKGROUND

Various dispatchers and dispatching techniques have been developed for assigning tasks based on affinity with a processor or processor group in multiprocessor systems. In the field of multiprocessor computer systems, it is often desirable to intelligently assign tasks (e.g., that are to be performed for one or more application programs executing on the system) to particular one(s) of the processors in an effort to improve efficiency and minimize overhead associated with performing the tasks. For instance, it may be desirable to assign tasks that are most likely to access the same data to a common processor or processor group to take advantage of cache memory of the processors. That is, by assigning tasks to the processor or processor group that has the most likely needed data already in local cache memory, efficiency may be improved, such as through reduced main memory accesses.

It can be difficult to strike the right balance of work assignments between the processors of a multiprocessor system so that tasks are completed in an efficient manner with a minimum of overhead. This appropriate balance may vary considerably depending on the needs of the system's users and to some extent upon the system architectures. It is often desirable to manage the assignment of tasks in a manner that does not require a majority of the available tasks to be assigned to a single processor (nor to any other small subset of all processors). If such an over-assignment of tasks to a small subset of all processors occurs, the small subset of processors is kept too busy to accomplish all its tasks efficiently while others are waiting relatively idle with few or no tasks to do. Thus the system will not operate efficiently. Accordingly, a management technique that employs a load balancing or work distribution scheme is often desirable to maximize overall system efficiency.

Multiprocessor systems are usually designed with cache memories to alleviate the imbalance between high performance processors and the relatively slow main memories. Cache memories are physically closer to their processors and so can be accessed more quickly than main memory. They are managed by the system's hardware and they contain copies of recently accessed locations in main memory. Typically, a multiprocessor system includes small, very fast, private cache memories adjacent to each processor, and larger, slower cache memories that may be either private or shared by a subset of the system's processors. The performance of a processor executing a software application depends on whether the application's memory locations have been cached by the processor, or are still in memory, or are in a close-by or remote processor's cache memory.

To take advantage of cache memory (which provides for quicker access to data because of cache's proximity to individual processors or groups of processors), it may be desirable to employ a task management scheme that assigns tasks based on affinity with a processor or processor group that has the most likely needed data already in local cache memory to bring about efficiencies. As is understood in this art, where a processor has acted on part of a problem (loading a program, running a transaction, or the like), it is likely to reuse the same data or instructions present in its local cache, because these will be found in the local cache once the problem is begun. Affinity may refer to a preference for a task, having executed on a processor, to execute next on that same processor or a processor with fast access to the cached data. (Tasks begun may not complete due to a hardware interrupt or for various other well-understood reasons not relevant to our discussion.)

Language in the computer arts is sometimes confusing as similar terms mean different things to different people and even to the same people in different contexts. Here, we use the word “task” as indicating a process. Tasks may consist of multiple independent threads of control any of which could be assigned to different processor groups or to a particular process.

The two above-mentioned desires of affinity and load balancing seem to be in conflict. Permanently retaining task affinity could lead to overloading some processors or groups of processors. Redistributing tasks to processors to which they have no affinity will yield few cache hits and slow down the processing overall. These problems get worse as the size of the multiprocessor computer systems gets larger.

Computer systems use switching queues and associated algorithms for controlling the assignment of tasks to processors. These algorithms are considered an Operating System (OS) function. When a processor is ready for a new task, it will execute the re-entrant code that embodies the algorithm that examines the switching queue. This code may be referred to as a “dispatcher,” which may determine the next task to do on the switching queue and do it.

Prior art dispatchers and dispatching techniques for assigning tasks based on affinity with processors are described further in the following U.S. patents: 1) U.S. Pat. No. 6,658,448 titled “System and method for assigning processes to specific CPUs to increase scalability and performance of operating systems;” 2) U.S. Pat. No. 6,996,822 titled “Hierarchical affinity dispatcher for task management in a multiprocessor computer system;” 3) U.S. Pat. No. 7,159,221 titled “Computer OS dispatcher operation with user controllable dedication;” 4) U.S. Pat. No. 7,167,916 titled “Computer OS dispatcher operation with virtual switching queue and IP queues;” 5) U.S. Pat. No. 7,287,254 titled “Affinitizing threads in a multiprocessor system;” 6) U.S. Pat. No. 7,461,376 titled “Dynamic resource management system and method for multiprocessor systems;” and 7) U.S. Pat. No. 7,464,380 titled “Efficient task management in symmetric multi-processor systems,” the disclosures of which are hereby incorporated herein by reference. While the above-incorporated U.S. patents disclose certain systems and dispatchers and thus aid those of ordinary skill in the art in understanding exemplary implementations that may be employed for assigning tasks based on affinity with processor(s), embodiments of the present invention are not limited to the exemplary systems or dispatchers disclosed therein.

In some instances, it may be desirable to emulate one processing environment within another “host” environment or “platform.” For instance, it may be desirable to emulate an OS and/or one or more instruction processors (IPs) in a host system. Processor emulation has been used over the years for a multitude of objectives. In general, processor emulation allows an application program and/or OS that is compiled for a specific target platform (or IP instruction set) to be run on a host platform with a completely different or overlapping architecture set (e.g., different or “heterogeneous” IP instruction set). For instance, IPs having a first instruction set may be emulated on a host system (or “platform”) that contains heterogeneous IPs (i.e., having a different instruction set than the first instruction set). In this way, application programs and/or an OS compiled for the instruction set of the emulated IPs may be run on the host system. Of course, the tasks performed for emulating the IPs (and enabling their execution of the application programs and/or OS running on the emulated IPs) are performed by the actual, underlying IPs of the host system.

As one example, assume a host system is implemented having a commodity-type OS (e.g., WINDOWS® or LINUX®) and a plurality of IPs having a first instruction set; and an operating system (e.g., OS 2200) may be implemented on such host system, and IPs that are compatible with the OS (and having an instruction set different from the first instruction set of the host system's IPs) may be emulated on the host system. In this way, the OS and application programs compiled for the emulated IPs instruction set may be run on the host system (e.g., by running on the emulated IPs). Additionally, application programs and a commodity-type OS that are compiled for the first instruction may also be run on the system, by executing directly on the host system's IPs.

One area in which emulated IPs have been desired and employed is for enabling an OS and/or application programs that have conventionally been intended for execution on mainframe data processing systems to instead be executed on off-the-shelf commodity-type data processing systems. For example, OS 2200 from UNISYS® Corp. my be executed on a server powered by LINUX®. Other examples of emulated environments are described further in: 1) U.S. Pat. No. 6,587,897 titled “Method for enhanced I/O in an emulated computing environment;” 2) U.S. Pat. No. 7,188,062 titled “Configuration management for an emulator operating system;” 3) U.S. Pat. No. 7,058,932 titled “System, computer program product, and methods for emulation of computer programs;” 4) U.S. Patent Application Publication Number 2010/0125554 titled “Memory recovery across reboots of an emulated operating system;” 5) U.S. Patent Application Publication Number 2008/0155224 titled “System and method for performing input/output operations on a data processing platform that supports multiple memory page sizes;” and 6) U.S. Patent Application Publication Number 2008/0155246 titled “System and method for synchronizing memory management functions of two disparate operating systems,” the disclosures of which are hereby incorporated herein by reference.

However, generic affinity algorithms may produce undesirable results. For example, in an emulated environment such as described above, affinity dispatching algorithms may create an unbalanced system in certain situations. One unbalanced system may results when a network processor interrupts an instruction processor when a network I/O completes. An emulated operating system interrupt service routine determines which activity is waiting for the completion of the network I/O, and activates that activity. The activity waiting for the completion of a network I/O may be affinitized to an instruction processor (IP). If the IP the activity is affinitized to is being used by another activity, the activity waiting for the completion of network I/O will not be scheduled until the activity currently on the IP gives up control. This delays resuming the activity after completion of the network I/O and results in a perceived increased network latency by the activity.

### SUMMARY

One solution may be to modify the affinity queue based on the scheduling of network I/O for an activity. For example, one embodiment is a method that includes detecting a completion of at least one of a network input operation and a network output operation, and identifying a communication task waiting for the completion. The method may also include adjusting a first affinity queue associated with the communication task, and executing the communication task in accordance with the adjusted first affinity queue.

Another embodiment may be a computer program product that includes a non-transitory computer-readable medium with code to perform the steps of detecting a completion of at least one of a network input operation and a network output operation, and identifying a communication task waiting for the completion. The medium may also include code to perform the steps of adjusting a first affinity queue associated with the communication task, and executing the communication task in accordance with the adjusted first affinity queue.

Yet another embodiment may be an apparatus that includes a memory and a processor coupled to the memory. The processor may be configured to execute the steps of detecting a completion of at least one of a network input operation and a network output operation, and identifying a communication task waiting for the completion. The processor may also be configured to execute the steps of adjusting a first affinity queue associated with the communication task, and executing the communication task in accordance with the adjusted first affinity queue.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1A is a block diagram illustrating an example of a conventional multiprocessor system having an operating system (“OS”) running directly on the system's instruction processor(s) (IPs), where the OS includes an affinity dispatcher for assigning tasks based on affinity with ones of the system's IPs.

FIG. 1B is a high-level block diagram of the OS 2200 mainframe (CMOS) architecture, which is one example of an architecture that includes an OS with an affinity dispatcher for managing tasks assigned among a system's IPs on which the OS is directly executing.

FIG. 2 is a block diagram illustrating one form of a multiprocessor computer system on which the exemplary system of FIG. 1A may be implemented, as well as which may be adapted to take advantage of embodiments of the present invention.

FIG. 3A is a block diagram of an exemplary conventional data processing system that employs emulated IPs on a host system with an OS running on the emulated IPs.

FIG. 3B is a high-level block diagram of an Emulated OS 2200 mainframe architecture, which is one example of an architecture that may be employed for implementing the emulated environment on the host system of FIG. 3A.

FIG. 4 shows a block diagram of an exemplary system according to one embodiment of the present invention.

FIG. 5 is a flow diagram that shows how the Intel Affinity identifier is passed to the instruction processor in accordance with one exemplary implementation of an embodiment of the present invention.

FIG. 6 is a flow chart diagram illustrating a method for network input/output affinity dispatching according to one embodiment of the disclosure.

FIG. 7 is a block diagram illustrating a computer network according to one embodiment of the disclosure.

FIG. 8 is a block diagram illustrating a computer system according to one embodiment of the disclosure.

FIG. 9A is a block diagram illustrating a server hosting an emulated software environment for virtualization according to one embodiment of the disclosure.

FIG. 9B is a block diagram illustrating a server hosting an emulated hardware environment according to one embodiment of the disclosure.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein, such as the operations for managing (e.g., by a dispatcher) assignment of tasks performed for an application program executing on emulated IPs among IPs of a host system that is hosting the emulated IPs, are implemented as a sequence of computer implemented steps, operations, or procedures running on a programmable circuit within a computer.

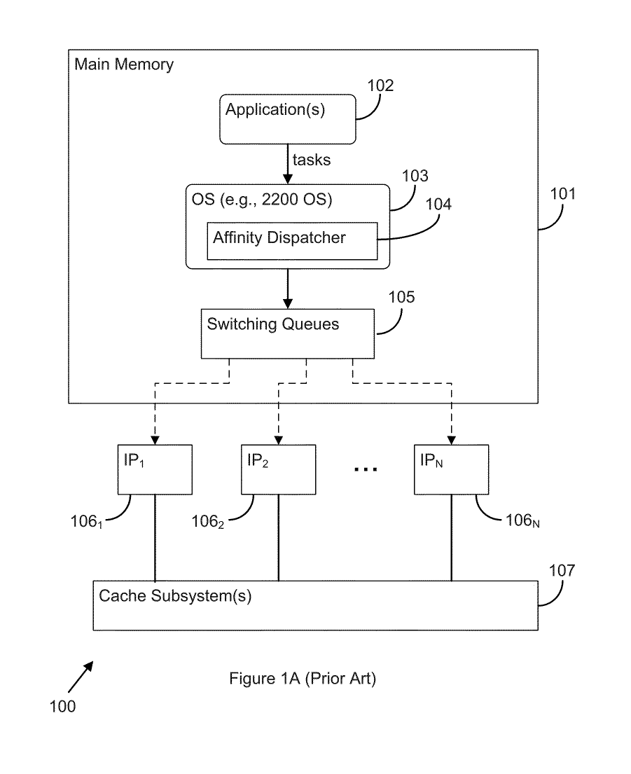

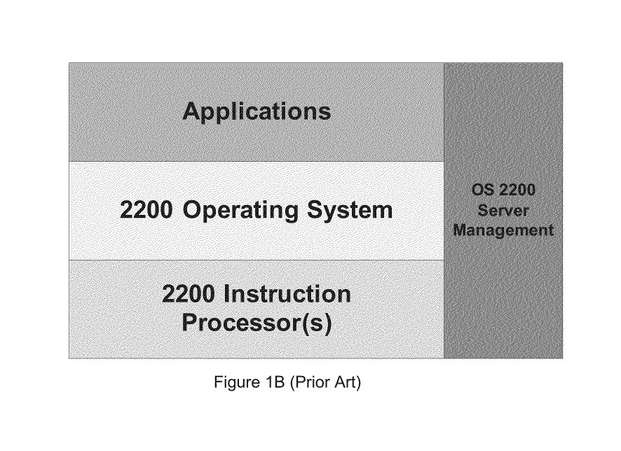

FIG. 1A shows a block diagram illustrating an example of a conventional multiprocessor system 100 having an operating system (“OS”) 103 that includes an affinity dispatcher 104 for assigning tasks based on affinity with ones of instruction processor(s) (IPs) 106. System 100 includes a main memory 101, a plurality of instruction processors (IPs) 106₁-106_{N} (collectively “the IPs 106”), and cache subsystem(s) 107. OS 103 is, in this example, adapted to execute directly on the system's IPs 106, and thus has direct control over management of the task assignment among such IPs 106.

In one example, system 100 provides an OS 103 that provides the data protection and recovery mechanisms needed for application programs that are manipulating critical data and/or must have a long mean time between failures. Such systems also ensure that memory data is maintained in a coherent state. In one exemplary embodiment, the OS 103 is the 2200 (CMOS) OS commercially available from the UNISYS® Corporation. Alternatively, the OS 103 may be some other type of OS, and the platform may be another enterprise-type environment.

Application programs (APs) 102 may communicate directly with OS 103. APs 102 may be, for example, those types of application programs that require enhanced data protection, security, and recoverability features generally only available on legacy mainframe platforms. OS 103 may manage the assignment of tasks (processes) to be performed for execution of the APs 102 among the IPs 106 on which the OS 103 and APs 102 directly run.

To take advantage of cache subsystems 107, which provides for quicker access to data because of cache's proximity to individual processors or groups of processors, OS 103 assigns tasks based on affinity with a particular one (or a particular group) of IPs 106 that has the most likely needed data already in local cache memory 107 to bring about efficiencies. In this example, OS 103 includes an affinity dispatcher 104, which uses switching queues 105 and associated algorithms for controlling the assignment of tasks to corresponding ones of the IPs 106. When an IP is ready for a new task, it will execute the re-entrant code that embodies the algorithm that examines the switching queue 105. It will determine the next task to do on the switching queue and do it.

Thus, as illustrated in FIG. 1A, dispatchers (e.g., dispatcher 104) and dispatching techniques for assigning tasks based on affinity with IPs 106 have been employed in systems where the OS 103 controls the IPs 106 directly (e.g., the application programs 102 execute directly on the system's IPs 106). As one example of an OS 103 that may be implemented in the manner described with FIG. 1A, the OS 2200 mainframe (CMOS) OS available from UNISYS® Corp. supports a mechanism called Affinity Dispatching. A high-level block diagram of the OS 2200 mainframe (CMOS) architecture is shown in FIG. 1B.

Affinity dispatching systems (e.g., dispatcher 104) may have the ability to configure switching queues 105 that correspond to cache neighborhoods. A large application program 102 may benefit from executing exclusively in some local cache neighborhood. In the 2200 mainframe (CMOS) architecture, for example, setting an affinity parameter to a non-zero value will cause all runs with original runid equal to one of the dedicated_runidx parameters to execute in a specific local cache neighborhood and all other runs to execute in the remaining cache neighborhoods. This and other techniques for implementing affinity-based task assignments and switching queues for affinity-based task assignment by a task manager (e.g., dispatcher in an OS) that is executing directly on the system's IPs are well-known in the art.

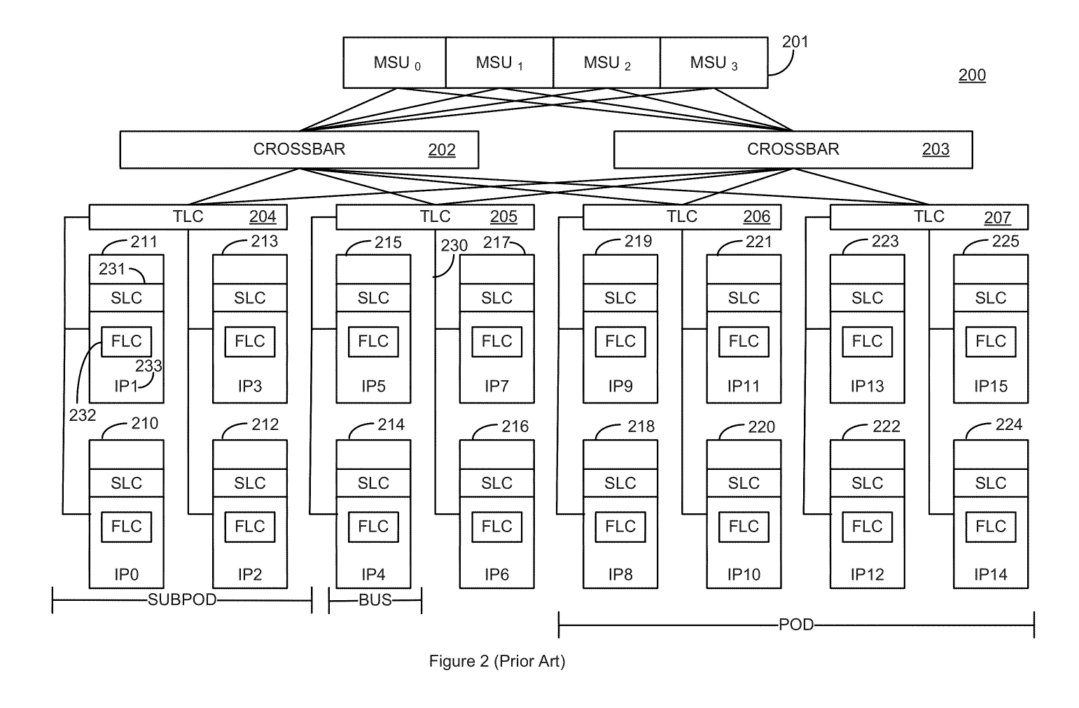

One form of a multiprocessor computer system 200 on which exemplary system 100 of FIG. 1A may be implemented, as well as which may be adapted to take advantage of embodiments of the present invention (as described further herein) is described with reference to FIG. 2. Larger versions can be built in a modular manner using more groups of components similar to the ones shown, but for purposes of this discussion a 16-processor version suffices. In the system illustrated in FIG. 2, there may be a central main memory 201 having a plurality of memory storage units MSU₀₋₃. These can be configured to form a long contiguous area of memory or organized into many different arrangements as is understood in this industry.

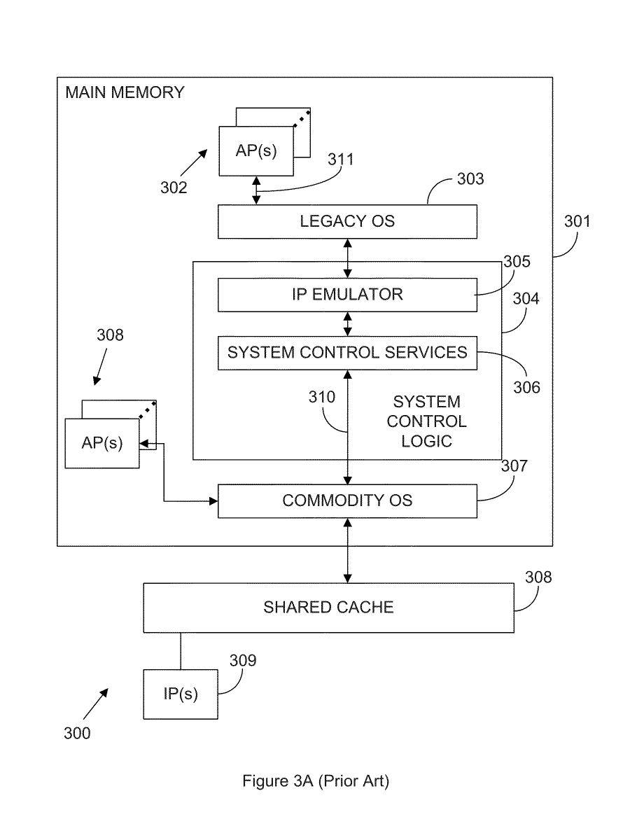

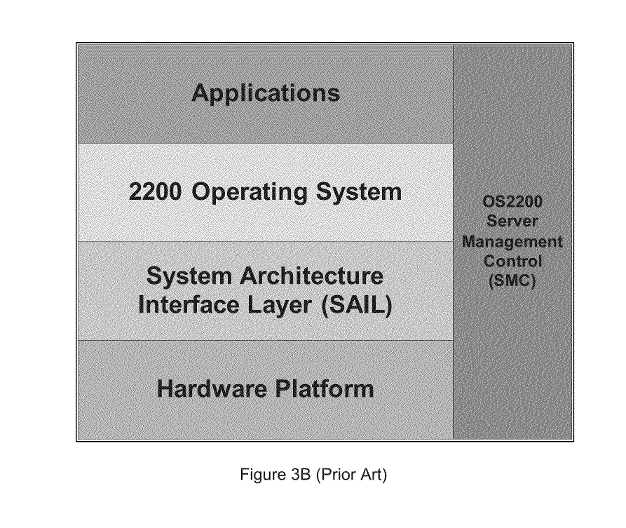

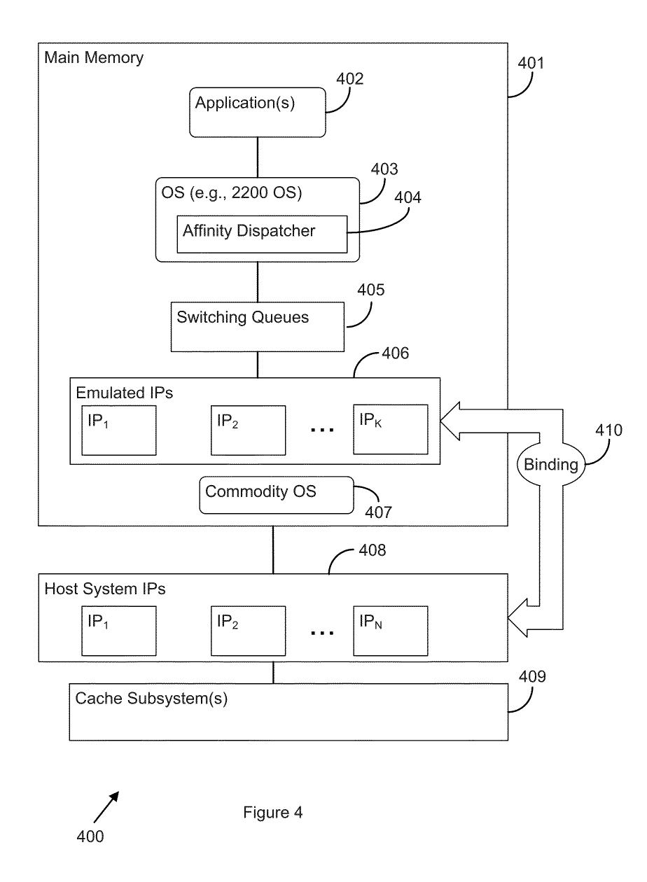

The MSUs 201 are each connected to each of the two crossbars 202, 203, which in turn are connected to the highest level of cache in this exemplary system, the Third Level Caches (TLCs) 204-207. These TLCs are shared cache areas for all the Instruction Processors (IPs) underneath them. Data, instruction and other signals may traverse these connections similarly to a bus, but advantageously by direct connection through the crossbars in a well-known manner. The processors IP₀₋₁₅ may, in certain implementations, be IPs of the “2200” variety in a Cellular MultiProcessing (CMP) computer system from UNISYS Corporation, as in the legacy platform of FIG. 1A. In other implementations, such as in a host system (e.g., commodity system) on which 2200-type IPs are emulated, such as described further below with FIGS. 3-4, the processors IP₀₋₁₅ may be configured with a different instruction set than the instruction set of the IPs being emulated. As an example, IPs of the 2200 variety may be emulated on the host system and a legacy OS (e.g., OS 2200) may be running on such emulated IPs, while the IPs of the underlying host system (the “hardware platform” or “commodity platform”) may have, for instance, an INTEL® processor core, such as the Nehalem INTEL processor microarchitecture for example.

In the example of FIG. 2, a store-through cache is closest to each IP, and since it is the first level cache above the IP, it is called for a First Level Cache (FLC). The second level caches and third level caches are store-in caches in the illustrated example of FIG. 2. The Second Level Caches (SLCs) are next above the FLCs, and each IP has its own SLC as well as a FLC in the exemplary implementation of FIG. 2.

Blocks 210-225, each containing a FLC, SLC and IP, may be connected via a bus to their TLC in pairs and that two such pairs are connected to each TLC. Thus, the proximity of the SLCs of IP₀ and IP₁ is closer than the proximity of IP₂ and IP₃ to the SLCs of IP₀ and IP₁. The buses are illustrated in FIG. 2 as single connecting lines. For example: TLC 205 may be coupled by bus 230 to blocks 217 and 216. Each of these buses is an example of the smallest and usually most efficient multiprocessor cache neighborhood in this exemplary implementation. Two threads that share data will execute most efficiently when confined to one of these cache neighborhoods.

Also, the proximity of IP₀₋₃ to TLC 204 is greater than the proximity of any of the other IP's to TLC 204. By this proximity, a likelihood of cache hits for processes or tasks being handled by most proximate IPs is enhanced. Thus, if IP₁ has been doing a task, the data drawn into SLC 231 and TLC 204 from main memory (the MSUs 201) is more likely to contain information needed for that task than are any of the less proximate caches (TLCs 205, 206, 207 and their SLCs and FLCs) in the system 200.

It should be noted that this system 200 describes a 16 IP system, and that with two additional crossbars, the system could be expanded in a modular fashion to a 32 IP system, and that such systems can be seen for example in the UNISYS Corporation CMP CS7802 computer system, and could also be applied to the UNISYS ES7000 computer system with appropriate changes to its OS, in keeping with the principles taught herein. It should also be recognized that neither number of processors, nor size, nor system organization is a limitation upon the teachings of this disclosure. For example, any multiprocessor computer system, whether NUMA (Non-Uniform Memory Architecture) architected or UMA (Uniform Memory Architecture) as in the detailed example described with respect to FIG. 2 could employ the teachings herein.

FIG. 3A is a block diagram of one exemplary embodiment of a conventional data processing system 300 that employs emulated IPs 305 on a host system with an OS 303 running on the emulated IPs 305. The host system may, for example, be a commodity-type data processing system such as a personal computer, workstation, or other “off-the-shelf” hardware. This system may include a main memory 301, which may optionally be coupled to a shared cache 308 or some other type of bridge circuit. The cache system 308 may be implemented, for example, in the manner described above with FIG. 2. The shared cache 308 is, in turn, coupled to one or more IPs 309 of the host system. In one embodiment, the IPs 309 include commodity-type IPs such as are available from Intel Corporation, Advanced Micro Devices Incorporated, or some other vendor that provides IPs for use in commodity platforms. The host system's IPs 309 may have a different instruction set as compared to the instruction set of the emulated IPs 305.

A commodity OS 307, such as UNIX®, LINUX®, WINDOWS®, or any other operating system adapted to operate directly on the host system's IPs 309, resides within main memory 301 of the illustrated system. The commodity OS 307 is natively responsible for the management and coordination of activities and the sharing of the resources of the host data processing system, such as task assignment among the host system's IPs 309.

According to the illustrated system, OS 303 may be loaded into main memory 301. This OS 303 may be the OS 2200 mainframe (CMOS) operating system commercially available from UNISYS® Corporation, or some other similar OS. This type of OS is adapted to execute directly on a “legacy platform,” which is an enterprise-level platform such as a mainframe that typically provides the data protection and recovery mechanisms needed for application programs (APs) 302 that are manipulating critical data and/or must have a long mean time between failures. Such systems may also ensure that memory data is maintained in a coherent state. In one exemplary embodiment, an exemplary legacy platform may be a 2200 data processing system commercially available from the UNISYS® Corporation, as mentioned above. Alternatively, this legacy platform may be some other enterprise-type environment.

In one adaptation, OS 303 may be implemented using a different machine instruction set than that which is native to the host system's IP(s) 309. This instruction set is the instruction set which is executed by the IPs of a platform on which OS 303 was designed to operate. In this embodiment, the instruction set may be emulated by IP emulator 305, and thus OS 303 and APs 302 run on the emulated IPs 305, rather than running directly on the host system's actual IPs 309.

IP emulator 305 may include any one or more of the types of emulators that are known in the art. For instance, the emulator may include an interpretive emulation system that employs an interpreter to decode each legacy computer instruction, or groups of legacy instructions. After one or more instructions are decoded in this manner, a call is made to one or more routines that are written in “native mode” instructions that are included in the instruction set of the host system's IP(s) 309. Such routines generally emulate operations that would have been performed by the legacy system. As discussed above, this may also enable APs 302 that are compiled for execution by an IP instruction set that is different than the instruction set of the host system's IPs 309 to be run on the system 300, such as by running on the emulated IPs 305.

Another emulation approach utilizes a compiler to analyze the object code of OS 303 and convert this code from the legacy instructions into a set of native mode instructions that execute directly on the host system's IP(s) 309. After this conversion is completed, the OS 303 may then execute directly on IP(s) 309 without any run-time aid of emulator 305.

IP emulator 305 may be coupled to System Control Services (SCS) 306. Taken together, IP emulator 305 and SCS 306 comprise system control logic 304, which provides the interface between APs 302 and OS 303 and commodity OS 307 in the illustrated exemplary system of FIG. 3A. For instance, when OS 303 makes a call for memory allocation, that call is made via IP emulator 305 to SCS 306. SCS 306 translates the request into the format required by API 310. Commodity OS 307 receives the request and allocates the memory. An address to the memory is returned to SCS 306, which then forwards the address, and in some cases, status, back to legacy OS 303 via IP emulator 305. In one embodiment, the returned address is a C pointer (a pointer in the C programming language) that points to a buffer in virtual address space. SCS 306 may also operates in conjunction with commodity OS 307 to release previously-allocated memory. This allows the memory to be re-allocated for another purpose.

Application programs (APs) 302 communicate and are dispatched by OS 303. These APs 302 may be of a type that is adapted to execute directly on a legacy IP emulator. APs 302 may be, for example, those types of applications that require enhanced data protection, security, and recoverability features generally only available on legacy platforms. The exemplary configuration of FIG. 3A allows these types of APs 302 to be migrated to a commodity platform through use of the emulated processing environment.

The system of FIG. 3A may further support APs 308 that interface directly with commodity OS 307. In this manner, the data processing platform supports execution of APs 302 that are adapted for execution on enterprise-type platforms, as well as APs 208 that are adapted for a commodity environment such as a PC.

Thus, as illustrated in FIG. 3A, an emulated processing environment (e.g., OS and/or application programs running on emulated IPs) may be implemented on a host system. However, in such an emulated environment, the OS 303 running on the emulated IPs 305 may not have direct control of the host system's IPs 309 in the manner that the OS 103 of FIG. 1A has over the IPs 106. Accordingly, management of task assignment among the host system's IPs 309 is largely out of the control of OS 303 running on the emulated IPs 305. For instance, affinity-based task assignment of the type performed by dispatcher 104 in the example of FIG. 1A may not be employed when the OS 303 is executing in an emulated processing environment, where the OS 303 controls the emulated IPs 305 but not the underlying IPs 309 of the host system.

As one example of an OS 303 that may be implemented in an emulated processing environment in the manner described with FIG. 3A, the Emulated OS 2200 mainframe operating system available from UNISYS® Corp. may be so implemented. A high-level block diagram of an Emulated OS 2200 mainframe architecture is shown in FIG. 3B. In FIG. 3B, the System Architecture Interface Layer (SAIL) is the software package between the OS 2200 and the commodity (e.g., INTEL) hardware platform. The SAIL software package may include the following components: SAIL Kernel—SUSE Linux Enterprise Server (SLES11) distribution with open source modifications; System Control (SysCon)—The glue that creates and controls the instruction processor emulators; SAIL Control Center—User interface to SAIL; Instruction Processor emulator—based on 2200 ASA-00108 architecture; Network emulators; and Standard Channel Input/Output processor (IOP) drivers.

As discussed above, in CMOS systems, such as that illustrated in FIGS. 1A-1B, the OS controls the IPs directly. However, in emulated systems, such as in the example of FIGS. 3A-3B, the System Architecture Interface Level (“SAIL”) (Linux) controls what 2200 IP executed on what underlying host system's IPs (e.g., Intel core(s)). In such emulated systems, there was no binding of the emulated processing environment (e.g., emulated IPs 305) to the underlying IPs 309 of the host system (e.g., the Intel cores), and thus management of the task assignments (e.g., through affinity-based task assignment) was not controlled by the OS 303 executing on the emulated IPs 305.

FIG. 4 shows a block diagram of an exemplary system 400 according to one embodiment of the present invention. In the illustrated example, an OS 403 may execute on emulated IPs 406 for supporting execution of application programs 402, similar to the OS 303 executing on emulated IPs 305 for supporting execution of application programs 302 in the system of FIG. 3A discussed above. Additionally, as with the commodity OS 307 discussed above with FIG. 3A, the host system of FIG. 4 may also include a native host commodity OS 407 that runs directly on the host system's IPs 408. Further, as with the cache 308 and host system IPs 309 in the exemplary system of FIG. 3A, the system 400 of FIG. 4 also includes host system IPs 408 and a cache subsystem 409.

In the exemplary embodiment of FIG. 4, a binding 410 may be provided in accordance with exemplary techniques described further herein for binding the host system's IPs 408 to emulated IPs 406. For example, the binding 410 may be created by calling sched_setscheduler1, which is a modified version of the Linux standard call sched_setscheduler with an affinity parameter added. Accordingly, through such binding 410 a task manager (e.g., the OS 403) running on emulated IPs 406 may use affinity-based dispatching algorithms for effectively controlling task assignments among the host system's IPs 408 in an intelligent manner that facilitates improved processing efficiency, such as to facilitate reuse of cached data residing in the cache subsystem 409 of a given one or group of host system IPs 408.

For instance, in the example of FIG. 4, OS 403 may include an affinity dispatcher 404 for assigning tasks based on affinity with processor(s), in a manner similar to the affinity dispatcher 104 described above with FIG. 1. To take advantage of cache subsystems 409 (which provides for quicker access to data because of cache's proximity to individual processors or groups of processors 408), OS 403 may assign tasks based on affinity with a particular one (or a particular group) of IPs 408 that has the most likely needed data already in local cache memory 409 to bring about efficiencies.

In this example, OS 403 includes an affinity dispatcher 404, which may use switching queues 405 and associated algorithms for controlling the assignment of tasks to corresponding ones of the emulated IPs 406. Of course, any affinity-based task management scheme/implementation may be employed in accordance with the concepts described herein, and thus embodiments of the present invention are not limited to any specific affinity dispatcher implementation. Because the host IPs 408 may be bound (through binding 410) to the emulated IPs 406, the OS 403 executing on the emulated IPs 406 is able to effectively manage the assignment of tasks among the host system IPs 408 (e.g., by managing the assignment of tasks among the emulated IPs 406, which are bound to ones of the host system's IPs 408). Binding 410 may be achieved in any suitable manner for associating one or more of emulated IPs 406 with a corresponding one or more of actual host system IPs 408.

As shown in FIG. 4, “N” number of host system IPs 408 may be implemented on host system, where N is two or more IP cores. Also, “K” number of IPs 406 may be emulated. K may equal N in certain embodiments, and K may be different (e.g., more or less) than N in other embodiments. Further, the binding 410 may not be a one-for-one binding between emulated IPs 406 and host system IPs 408. For instance, a plurality of emulated IPs 406 may be bound to a single host system IP 408 and/or vice versa in certain embodiments. The binding 410 need not be a permanent binding, but instead the binding 410 may dynamically vary. That is, ones of host system IPs 408 that are bound to corresponding ones of emulated IPs 406 may dynamically change over time, such as over the course of application programs 402 being initiated, terminated, interrupted, etc.

While a specific, concrete exemplary host system and emulated IPs on which an exemplary OS is running are described further herein for illustrative purposes, embodiments are not limited to any particular OS that is executing for an emulated environment, nor are embodiments limited to any particular IP instruction set for IPs that are being emulated. Further, embodiments are likewise not limited to any particular OS that may natively reside on a host system, nor are embodiments limited to any particular IP instruction set for underlying IPs of a host system that is hosting the emulated IPs.

While many illustrative examples are provided wherein an OS is running on emulated IPs that are hosted on a commodity-type host platform, embodiments are not limited to such implementations. As those of ordinary skill in the art will readily appreciate, the concepts disclosed herein may be employed when any type of OS is running on any type of emulated IPs that are being hosted on any type of host platform.

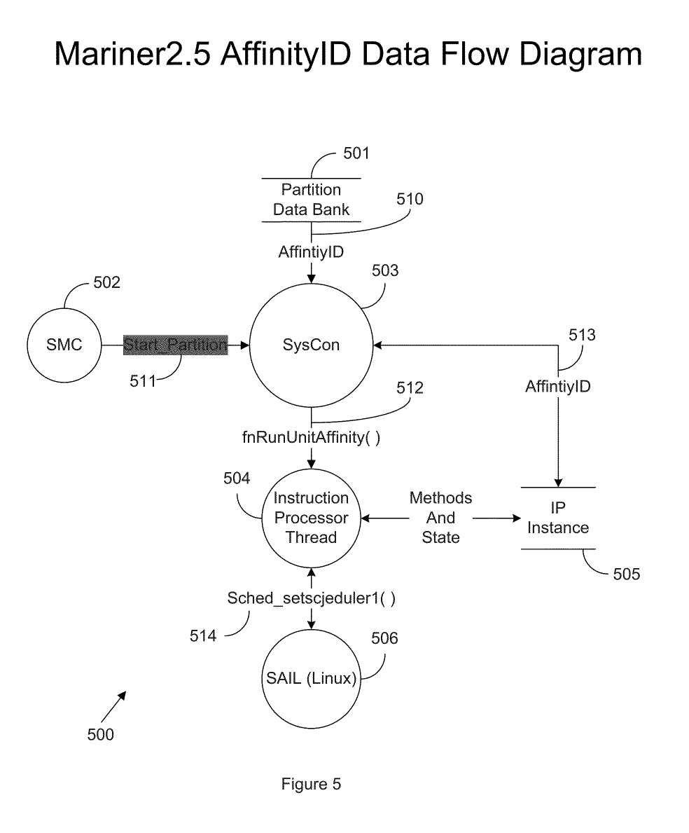

An affinity identifier may be passed to the instruction processor by the following steps, with reference to the flow diagram of FIG. 5. A SysCon 503 may retrieve, in operation 510, an affinity ID for each IP from the PDB IP handler data 501, using the IP UPI number, during initialization of, for example, the OS 2200 environment. The retrieved affinity ID of each IP may be stored in the respective IP objects in operation 513. When SMC 502 sends, in operation 511, START_PARTITION command, SysCon 503 may initialize the OS environment and start the 2200 instruction emulator thread 504, by calling the fnRunUnitAffinity function in operation 512, and specifying the IP UPI number and the affinity ID in operation 513. If the fnRunUnitAffinity interface is not available, the standard Linux fnRunUnit function may be called without specifying the affinity ID. An instruction emulator thread 504, such as fuRunUnitAffinity, passes the affinity ID to SAIL 506 by calling the sched_setscheduler1 API in operation 514. If the affinity ID is zero or if the call fails the sched_setscheduler API may be used.

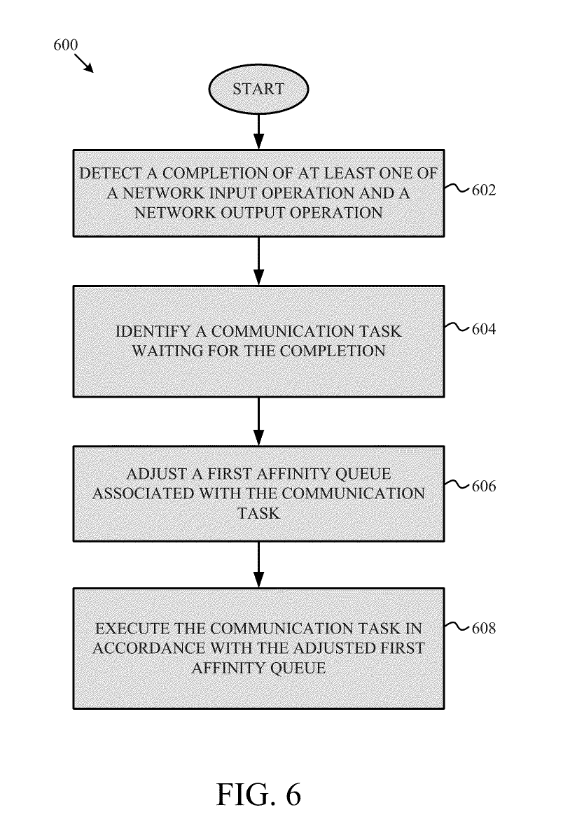

Affinities for applications to instruction processors may be aligned to improve responsiveness of a system executing the applications. For example, applications waiting on network input/output may have affinities assigned based on completion of the network input/output requests. FIG. 6 is a flow chart diagram illustrating a method for network input/output affinity dispatching according to one embodiment of the disclosure. Method 600 starts at block 602 with detecting a completion of at least one of a network input operation and a network output operation. In some embodiments, an IP may be interrupted upon detecting the completion of the network input and/or output operation. According to an embodiment, the input and/or output operations may include network communication operations. A communication task waiting for the completion of the network input and/or output operation may be identified at block 604. According to one embodiment, the identified communication task may include one or more instructions or threads for performing a network communication operation. At block 606, a first affinity queue associated with the identified communication task may be adjusted, and at block 608, the communication task may be executed in accordance with the adjusted first affinity queue. According to an embodiment, the first affinity queue may be the switching queue that schedules (e.g., dispatches) the communication task.

In some embodiments, adjusting the first affinity queue may include matching the first affinity queue to a second affinity queue associated with one or more instructions for identifying the communication task, such as at block 604. For example, according to one embodiment, an interrupt service routine of an OS may search for and identify the communication task waiting for the completion of the network input and/or output operation, such as at block 604. The interrupt service routine may then adjust the affinity queue of the communication task (e.g., the first affinity queue), such as at block 606, to match the affinity queue running (e.g., scheduling) the interrupt service routine. According to one embodiment, the second affinity queue may be the switching queue that schedules (e.g., dispatches) the interrupt service routine. In some embodiments, when the interrupt service routine finishes, the communication task waiting for the completion of the network input and/or output operation may be selected for execution, such as at block 608. By executing the communication task when the interrupt service routine finishes, the latency for network input and/or output operations may be reduced.

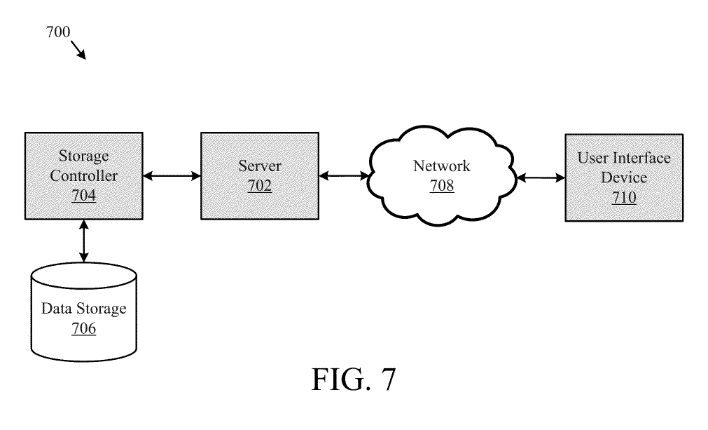

FIG. 7 illustrates one embodiment of a system 700 for input/output affinity dispatching in a computer network according to one embodiment of the disclosure. The system 700 may include a server 702, a data storage device 706, a network 708, and a user interface device 710. The server 702 may also be a hypervisor-based system executing one or more guest partitions hosting operating systems with modules having server configuration information. In a further embodiment, the system 700 may include a storage controller 704, or a storage server configured to manage data communications between the data storage device 706 and the server 702 or other components in communication with the network 708. In an alternative embodiment, the storage controller 704 may be coupled to the network 708.

In one embodiment, the user interface device 710 is referred to broadly and is intended to encompass a suitable processor-based device such as a desktop computer, a laptop computer, a personal digital assistant (PDA) or tablet computer, a smartphone or other mobile communication device having access to the network 708. In a further embodiment, the user interface device 710 may access the Internet or other wide area or local area network to access a web application or web service hosted by the server 702 and may provide a user interface for enabling a user to enter or receive information.

The network 708 may facilitate communications of data between the server 702 and the user interface device 710. The network 708 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

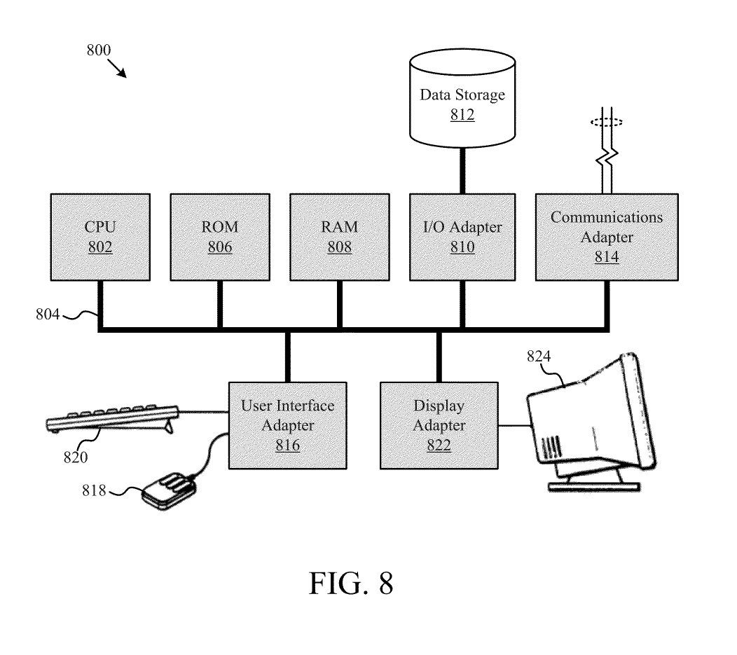

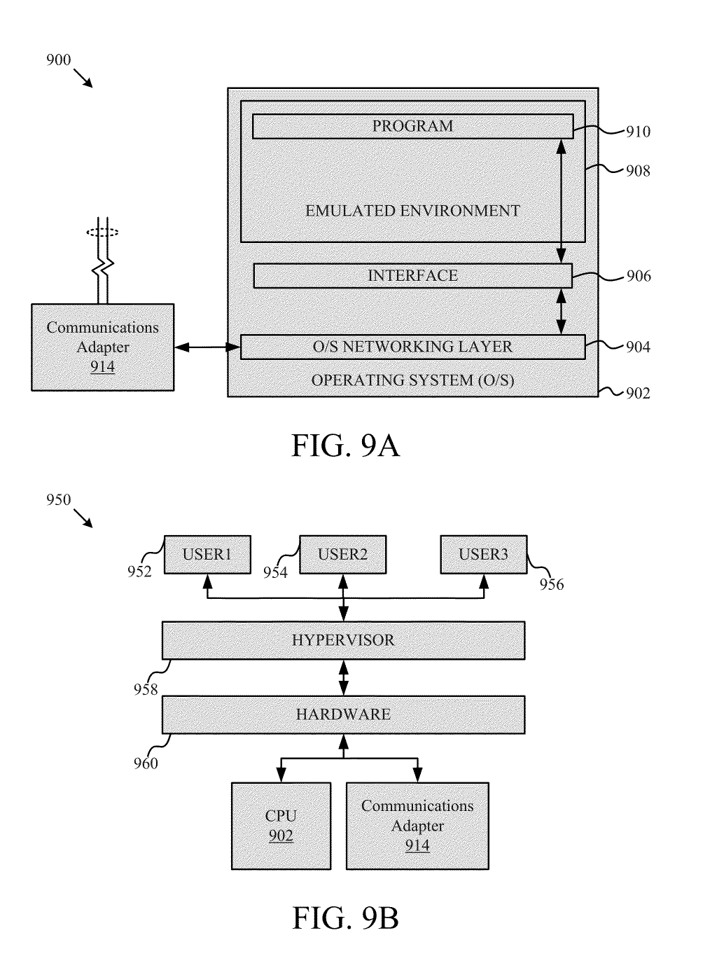

FIG. 8 illustrates a computer system 800 adapted according to certain embodiments of the server 702 and/or the user interface device 710. The central processing unit (“CPU”) 802 is coupled to the system bus 804. The CPU 802 may be a general purpose CPU or microprocessor, graphics processing unit (“GPU”), and/or microcontroller. The present embodiments are not restricted by the architecture of the CPU 802 so long as the CPU 802, whether directly or indirectly, supports the operations as described herein. The CPU 802 may execute the various logical instructions according to the present embodiments.

The computer system 800 may also include random access memory (RAM) 808, which may be synchronous RAM (SRAM), dynamic RAM (DRAM), synchronous dynamic RAM (SDRAM), or the like. The computer system 800 may utilize RAM 808 to store the various data structures used by a software application. The computer system 800 may also include read only memory (ROM) 806 which may be PROM, EPROM, EEPROM, optical storage, or the like. The ROM may store configuration information for booting the computer system 800. The RAM 808 and the ROM 806 hold user and system data, and both the RAM 808 and the ROM 806 may be randomly accessed.

The computer system 800 may also include an input/output (I/O) adapter 810, a communications adapter 814, a user interface adapter 816, and a display adapter 822. The I/O adapter 810 and/or the user interface adapter 816 may, in certain embodiments, enable a user to interact with the computer system 800. In a further embodiment, the display adapter 822 may display a graphical user interface (GUI) associated with a software or web-based application on a display device 824, such as a monitor or touch screen.

The I/O adapter 810 may couple one or more storage devices 812, such as one or more of a hard drive, a solid state storage device, a flash drive, a compact disc (CD) drive, a floppy disk drive, and a tape drive, to the computer system 800. According to one embodiment, the data storage 812 may be a separate server coupled to the computer system 800 through a network connection to the I/O adapter 810. The communications adapter 814 may be adapted to couple the computer system 800 to the network 708, which may be one or more of a LAN, WAN, and/or the Internet. The user interface adapter 816 couples user input devices, such as a keyboard 820, a pointing device 818, and/or a touch screen (not shown) to the computer system 800. The display adapter 822 may be driven by the CPU 802 to control the display on the display device 824. Any of the devices 802-822 may be physical and/or logical.

The applications of the present disclosure are not limited to the architecture of computer system 800. Rather the computer system 800 is provided as an example of one type of computing device that may be adapted to perform the functions of the server 702 and/or the user interface device 710. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 800 may be virtualized for access by multiple users and/or applications.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

The steps of a method or algorithm described in connection with the disclosure herein (such as that described in FIG. 5 or 6 above) may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

In one or more exemplary designs, the functions described may be implemented in hardware, software, firmware, or any combination thereof. If implemented in software, the functions may be stored as one or more instructions or code on a computer-readable medium which are processed/executed by one or more processors.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method for network input/output affinity dispatching, comprising:
detecting, at a communications processor, a completion of at least one of a network input operation and a network output operation corresponding to a communication task;
identifying, by an interrupt service routine, an application associated with the communication task; and
adjusting, by the interrupt service routine, a first affinity queue associated with the communication task.

2. The method of claim 1, further comprising executing the application in accordance with the adjusted first affinity queue.

3. The method of claim 2, wherein the application comprises one or more instructions for performing a communication operation.

4. The method of claim 1, wherein the step of adjusting the first affinity queue comprises matching the first affinity queue to a second affinity queue associated with the communications processor.

5. The method of claim 1, further comprising interrupting a processor upon detecting the completion of the at least one network operation.

6. A computer program product, comprising:
a non-transitory computer-readable medium comprising code to perform the steps of:
detecting, at a communications processor, a completion of at least one of a network input operation and a network output operation corresponding to a communication task;
identifying, by an interrupt service routine, an application associated with the communication task; and
adjusting, by the interrupt service routine, a first affinity queue associated with the communication task.

7. The computer program product of claim 6, wherein the medium further comprises code to perform the step of executing the application in accordance with the adjusted first affinity queue.

8. The computer program product of claim 7, wherein the application comprises one or more instructions for performing a communication operation.

9. The computer program product of claim 6, wherein the step of adjusting the first affinity queue comprises matching the first affinity queue to a second affinity queue associated with the communications processor.

10. The computer program product of claim 6, further comprising code to perform the step of interrupting a processor upon detecting the completion.

11. An apparatus, comprising:
a memory; and
a processor coupled to the memory, the processor configured to execute the steps of:
detecting, at a communications processor, a completion of at least one of a network input operation and a network output operation corresponding to a communication task;
identifying, by an interrupt service routine, an application associated with the communication task; and
adjusting, by the interrupt service routine, a first affinity queue associated with the communication task.

12. The apparatus of claim 11, wherein the apparatus if further configured to perform the step of executing the application in accordance with the adjusted first affinity queue.

13. The apparatus of claim 12, wherein the application comprises one or more instructions for performing a communication operation

14. The apparatus of claim 11, wherein the step of adjusting the first affinity queue comprises matching the first affinity queue to a second affinity queue associated with the communications processor.

15. The apparatus of claim 11, wherein the processor is further configured to execute the step of interrupting a processor upon detecting the completion.
